(19) United States
(12) Patent Application Publication
(10) Pub. No.: US 2021/0114828 A1
(43) Pub. Date: Apr. 22, 2021

(54) Automatic self-unloading material handling system

(71) Applicants: Jeff Phlipot, Sidney, OH (US); Mark Schneider, Piqua, OH (US)

(72) Inventors: Jeff Phlipot, Sidney, OH (US); Mark Schneider, Piqua, OH (US)

(21) Appl. No.: 17/075,611

(22) Filed: Oct. 20, 2020

Related U.S. Application Data
(60) Provisional application No. 62/923,766, filed on Oct. 21, 2019.

(51) Int. Cl. B65G 65/48; B65G 67/24; B65G 65/00; B60P 1/52

(52) U.S. Cl. CPC B65G 65/4881; B60P 1/52; B65G 65/005; B65G 67/24

(57) ABSTRACT

Aspects of the present disclosure provide an automatic self-unloading material handling system that replace conventional material handling unloading systems. The automatic material handling unloading comprising a container with a roller assembly floor; a moveable bulkhead; a control enclosure; gear drive guide track assemblies; gear drive assemblies; a power track; a battery; and a power collector. Particularly, an Automatic self-unloading material handling system constructed as set out herein, can be configured and programmed to satisfy user-specified dimensions and load ratings, dynamic loading, ect, while provide a material handling unloading system that is lighter than what is realized in conventional unloading systems at comparable dimensions and load ratings. The automatic self-unloading material handling system is programmable with automated features to unload cargo from a container autonomously.

### BACKGROUND

Various aspects of the present disclosure relate generally to a material handling system, and specifically to an automatic self-unloading material handling system, and a method of fabricating the automatic self-unloading material handling system.

Large containers are often utilized for storing items and/or for transporting items from one location to another. For instance, a semi-trailer is a type of container that is pulled by a road tractor, thus providing a convenient and widely used means to transport goods across public roads including interstates, highways, and other roadways. One of the most common types of semi-trailer, known as a box trailer, is essentially a box-shaped container on wheels, making the semi-trailer suitable for temporarily storing, securing, and hauling various types of cargo.

Cargo, which can be palletized, is loaded into the container for transportation. For instance, workers operating forklift trucks, pallet jacks, and other materials handling devices can cooperate to move cargo into the trailer for transportation to a desired destination. By means of loading/unloading the container by manpower, forklifts, pallet jacks, other material handling devices, or a combination thereof a considerable amount of time is consumed. It is desirable to efficiently load/unload the container without the need to enter/exit the container. The present disclosure for the automatic self-unloading material handling system presents an efficient and expedient way to unload cargo.

### BRIEF SUMMARY

Aspects of the present disclosure provide an automatic self-unloading material handling system that replace conventional material handling unloading systems. The automatic self-unloading material handling system comprising a container with a roller assembly floor; a bulkhead assembly; a control enclosure; gear drive guide track assemblies, comprising a gear drive chain and a composite material formed as a track; a power track; a battery; gear drive assemblies; and a power collector. Particularly, the automatic self-unloading material handling system constructed as set out herein, can be configured and programmed to satisfy user-specified dimensions and load ratings, dynamic loading, ect, while provide a material handling unloading system that is lighter than what is realized in conventional unloading systems at comparable dimensions and load ratings. The automatic self-unloading material handling system is programmable with automated features to unload cargo from a container autonomously.

Further, the automatic self-unloading material handling system having the bulkhead assembly coupled to the gear drive assemblies. The gear drive assemblies are coupled to the gear drive assembly chains. The gear drive guide track assemblies are coupled to the container. The bulkhead assembly comprising key drive shafts; gear sprockets; an endless drive shaft chain, a motor assembly, comprising a motor and a through shaft speed reducer, and a frame assembly comprising beams, a rectangular frame, and friction reducing couplings. Wherein, the motor assembly, controlled by the control enclosure, rotates the key drive shafts causing the bulkhead assembly to move over the roller assemblies from the front/rear of the container to the rear/front of the container.

Further, the automatic self-unloading material handling system comprising a battery system. The battery system provides the automatic self-unloading material handling system capability to be powered autonomously without external power or externally by facility power, and other external power sources. The automatic self-unloading material handling system is a self-contained system capable of operating autonomously to unload the cargo of the container. The automatic self-unloading material handling system, operates autonomously utilizing control eyes in communication with the programmable logic center to allow for user-specific unloading and automation needs. The automatic self-unloading material handling system, programed with a return function allows the bulkhead to return to the front of the container after the container is unloaded. The automatic self-unloading material handling system allows for the container to be rapidly unloaded, and then loaded. The automatic self-unloading material handling system decrease downtime from unloading the container, and increases productivity.

### BRIEF DESCRIPTION OF THE SEVERAL VIEWS OF DRAWINGS

FIG. 1—a side view of a container, with the automatic self-unloading material handling system contained within.

FIG. 2—a rear view of the bulkhead assembly

FIG. 3—a front view of the frame assembly, with the composite skin illustrated as transparent

FIG. 4—a top view of the container

FIG. 5—a side view of a container, with the automatic self-unloading material handling system contained within, showing the control station and the control eyes.

FIG. 6—a close up sided view of the bulkhead assembly

FIG. 7—a view of the control enclosure

### DETAILED DESCRIPTION

Aspects of the present disclosure provide an automatic self-unloading material handling systems that replace conventional material handling unloading systems. The automatic self-unloading material handling systems comprising a container with a roller assembly floor; a moveable bulkhead assembly; a control enclosure; gear drive guide track assemblies; gear drive assemblies; a power track; and a power collector. Particularly, the automatic self-unloading material handling system constructed as set out herein, can be configured and programmed to satisfy user-specified dimensions and load ratings, dynamic loading, ect, while providing a material handling unloading system that is lighter than what is realized in conventional unloading systems at comparable dimensions and load ratings. In this regard, the automatic self-unloading material handling systems described herein are particularly well suited for applications such as in a container used to convey materials, an embodiment of such a container would be a container pulled by a tractor such as a semi-trailer.

Moreover, the automatic self-unloading material handling systems described herein replace conventional container unloading systems. Particularly, the automatic self-unloading material handling system constructed as set out herein is a self-contained autonomous system that can be operated, if desired, without the assistance of a facility power, or the power of the tractor. Conventional unloading systems solely rely on facility power, or power provided by a tractor, or external power. The automatic self-unloading material handling system described herein overcomes this conventional hurdle by using lightweight construction materials, and utilizing a rechargeable battery powered system. Unlike conventional unloading systems, the system describe herein, allows the system to be operated autonomously. In this regard, the automatic self-unloading material handling systems described herein are particularly suited to be utilized where the container or semi-trailer can be unhitched from the tractor, left to be unloaded later without the assistance or reliance on power being provided externally.

Moreover, the automatic self-unloading material handling system can, if desired, be configured to run with the assistance of facility power, or power provided by a tractor, or external power. The automatic self-unloading material handling system, uniquely provides the user the ability to use external power to run the system, and the option to utilize the system without external power.

Moreover, the automatic self-unloading material handling system described herein replaces conventional container unloading systems. In the addition of overcoming the challenge of creating enough force from stored energy to unload the container, the automatic self-unloading material handling system described herein is adapted to solar panels to sustain the automatic self-unloading material handling system battery power system.

Moreover, the light weight construction, the incorporated power supply, and the ability to program the rate of the unloading speed to a user specific dimensions at which the automatic self-unloading material handling system can unload a container decreases the downtime associated with conventional methods of unloading a container. The automatic self-unloading material handling system can be backed to a dock, and without the assistance of other material handling machines, such as forklifts, can unload the entire load faster than conventional methods.

Moreover, the automatic self-unloading material handling system described herein provides for a system with greater stability than conventional material handling systems. The automatic self-unloading material handling system has at least four points of contact with the container. This allows the system to overcome conventional systems by providing a system that is stable and needs less maintenance than conventional systems. The bulkhead assembly provides contact to the entire load instead of a portion of the load as in conventional push bar systems, allowing for greater stability eliminates toppling of unstable cargo.

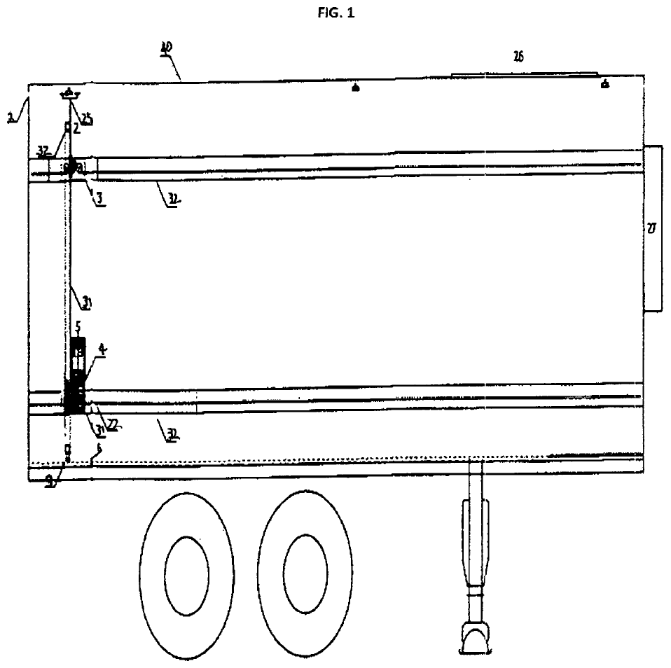

Referring now to the drawings, and in particular to FIG. 1 a container 40, in this figure depicted as a semi-trailer, that contains the automatic self-unloading material handling system is constructed in accordance with an embodiment of the present disclosure. The automatic self-unloading material handling system depicted in in FIG. 1. is shown where the system is installed inside of a material handling container. The container is conventionally an enclosed container that has a left wall, a right wall, a front wall, a ceiling, and a rear opening that can be enclosed. Another embodiment of a container would be a semi-trailer container used to transport material by road. Additional embodiments of containers that can be used to house the automatic self-unloading material handling system are cargo containers, shipping containers, vans, storage containers, and cargo planes.

The automatic self-unloading material handling system as shown in FIG. 1 includes in general, a control enclosure 27 (also referred to as a control panel), gear drive guide tracks assembly 30, gear drive assemblies 3, a power track 1, a power collector 25, a bulkhead assembly 31, a motor assembly 5, and a roller assembly floor 6.

Likewise, as illustrated in FIG. 1, the gear drive assembly guide tracks (also referred to as guide track) 30 are coupled to the side walls of the container. Each guide tracks 30 form a continuous smooth surface that is configured as a track for the gear drive assembly 3 and houses a gear drive chain 22 coupled to the guide track 30. The gear drive assembly 3 is coupled to the gear drive chain 22 and moves along the gear drive chain 22 coupled to the guide track 30.

The guide track 30 can be made from various different components. An embodiment of a guide track utilizes light weight durable sheet metal to construct the guide tracks. Another embodiment could use durable plastic to construct the guide tracks. Another embodiment comprising guide tracks constructed of a resin composite. FIG. 1 is a side view of the container and shows two guide tracks 30. The guide tracks 30 are located on the top portion of the side walls of the container, and on the lower portion of the side walls of the container. Additionally, both the side walls would have similar placements of the guide tracks 30. The guide tracks 30 are coupled to the side walls to keep the floor open in order for palletized material, and non-palletized material, to be loaded and loaded without encumbrance.

The power track 1 is a illustrated in FIG. 1 for the sake of discussion. The power track 1 is a conduit to deliver power from a variable frequency drive within the control enclosure 27 to the power collector 25 to the motor assembly 5. However, in certain applications, delivery of the power from the control enclosure 27 to the power collector 25 may not need the power collector 25. In yet further configurations, the power deliver may not need a power track 1. In an embodiment, the power track houses a power delivery method as copper wiring. Another embodiment may utilize industrial grade wiring.

As illustrated in FIG. 1 the bulkhead assembly 31 is coupled to the motor assembly 5. The motor assembly 5 is coupled to the key drive shafts 12. The key drive shafts are coupled to the gear drive assemblies 3. The gear drive assemblies are coupled to the gear drive chains 22, that are coupled to the gear drive guide tracks 30. This configuration provides for a stable bulkhead to move along the bottom floor comprising a roller floor 6. The gear drive assemblies 3 drives along the gear drive chain 22, in the gear drive guide track assemblies 30 propelling the bulkhead assembly 31 from the front/rear of the container to the rear/front of the container. The bulkhead assembly 31 can be propelled from the front/rear of the container to the rear/front of the container. An embodiment of the system allows the bulkhead assembly 31 to be moved across the rollers. Another embodiment of the system is where the bottom of the bulkhead 31 is coupled to casters 9.

The bottom floor of the container comprises a roller floor assembly 6. The roller floor assembly 6 is light weight milled cylinders that allow for cargo to move smoothly and effortlessly across the roller floor assembly 6. The roller floor assembly 6 is such that it can be configured to accommodate heavy palletized loads, and still move the palletized load with minimal effort. In the illustrative example, the roller assembly 6 is placed in a longitudinal direction to the container in the middle of the bottom floor. Also, in certain applications, the roller floor 6 may contain only a few rollers. An embodiment, the roller floor is evenly spaced and distributed along the container floor, moving freely. Another embodiment, the roller floor may be energized to move in concert with the bulkhead. Another embodiment, the rollers can be made out of metal tubing. Another embodiment the rollers can be made out of composite materials.

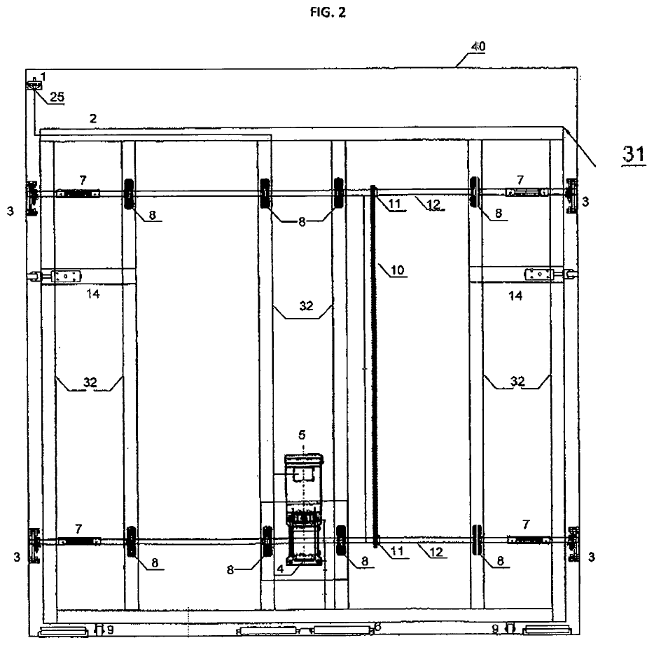

Referring to FIG. 2, the bulkhead assembly (also referred to as “bulkhead”) 31, of FIG. 1 is shown with in a close up view. As illustrated, the bulkhead comprises a rectangular frame assembly 2; key drive shaft assemblies 12; a motor assembly 5; and a composite skin covering. The bulkhead 31 has four points of contact to four gear drive assemblies 5, coupled to a respective gear drive guide track assembly 30, to support the upright position of the bulkhead 31. The bulkhead 31 moves smoothly within the container.

In the illustrated configuration the frame assembly 2 comprising a rectangular frame and support beams 32 vertically placed within the rectangular frame assembly 2 for support. Moreover, the frame assembly 2 comprises a lightweight composite material. An embodiment of the frame assembly constructed from lightweight aluminum. Another embodiment the frame assembly comprises a composite wood material. Another embodiment the frame assembly can comprise steel, hardened plastic, solid castings, or various building materials.

In the illustrated configuration, the beams 32 are coupled to the frame assembly 2. The beams 32 comprising top distal ends; bottom distal ends; and friction reducing couplers. The distal ends of the beams are coupled to the frame assembly 2. The top distal ends are coupled to the top portion of the frame assembly 2. The lower distal end is coupled to the bottom portion of the frame assembly 2. The beams 32 comprise a light weight building material to provide structure to the bulkhead. Moreover, the beams 32 can be a composite material or a simple material. An embodiment the beams 32 comprising aluminum tubing. Another embodiment the beams 32 comprising light weight steel. Another embodiment the beams 32 comprising hardened plastic. Another embodiment the beams 32 comprising wood, or various composite building materials

In the illustrated configuration, the friction reducing couplers 8 are coupled to the beams 32 proximal to the top distal end of the beams and proximal to the bottom distal ends of the beams 32. The friction reduction couplings 8 are aligned to allow the key drive shafts coupled to the friction reduction couplings 8 levelly, coupling the key drive shafts 12 to the beams, and the beams are coupled to the frame assembly 2. The friction reduction couplings 8 are a composite that can comprise metal, plastic, a composite material or a solid material. Additionally, the friction reduction couplings 8 can be made of a ball bearing application. An embodiment of a friction reduction couplings 8 are pillow block bearings. Another embodiment of a friction reduction coupling 8 is a roller bearing. Also, in certain applications, the friction reduction couplings may be removed provided that the key drive shaft maintains a frictionless coupling to the beams.

In the illustrated configuration, the bulkhead has key drive shaft assemblies 12, wherein there is a top key drive shaft assembly and a lower key drive shaft assembly 12. In the illustrated configuration, the key drive shafts 12, are coupled to the friction reduction couplings 8 coupled to the beams 32. The key drive shafts 12, have left distal ends; right distal ends; a first midpoint; and a key portion. The key drive shafts 12 are longitudinal in orientation to the bulkhead. Moreover, the left distal end of the key drive shafts are coupled to a left spline slip coupling 7. The right distal ends of the key drive shafts 12 are coupled to a right spline slip coupling 7. The spline slip couplings 7 are respectively coupled to a corresponding gear drive assembly 3, the gear drive assembly 3, is coupled to the gear drive chain 22, the gear drive chain 22 is coupled to the gear drive guide track assembly 30. The key drive shafts 12 key portion is located between the first midpoint and the right distal end. The key portion is coupled to a gear sprocket, with an internal diameter with a matching key portion within the internal diameter that the key drive shaft can pass through. Wherein, the gear sprocket is coupled to an endless drive shaft chain 10.

Moreover, the endless drive shaft chain 10 is coupled to the top key drive shaft gear sprocket and to the lower key drive shaft gear sprocket. As The endless drive shaft chain rotates the top key drive shaft and the bottom key drive shaft move in concert.

Moreover, the key drive shaft 12 comprises a material that can be either a solid or a composite material. The key drive shaft 12 comprises a light weight material that can withstand the mechanical stress of rotation. The entire key drive shafts 12 rotate in relation to the endless drive chain 10. The key drive shaft 12 drives the gear drive assembly 3. An embodiment the drive shaft is a solid material formed from a molding. Another embodiment, the drive shaft can be multiple units coupled together to form the drive shaft 12. Another embodiment, the drive shaft 12 can be hollow to conserve weight allowing the system to use less force. In the embodiments, the drive shaft 12 maintains a rigid form and has strength to withstand the torsional force enacted on it. An embodiment the key drive shafts are steel. Another embodiment the key drive shafts are aluminum. Another embodiment the key drive shafts are a composite metal. Another embodiment the key drive shafts are hardened plastic.

In the illustrated configuration, the lower key drive shaft 12 feeds through the lower aligned friction reducing couplers 8, coupling the key drive shaft 12 to the beams 32, levelly proximal to the bottom distal end of the beams 8 coupled to the frame assembly 2. Further, the lower key drive shaft 12 is coupled to the motor assembly 5. The motor assembly 5 drives the lower key drive shaft 12, and lower key drive shaft turns the gear sprocket 11 coupled to the drive shaft 12 at the key portion. As the gear sprocket rotates 11, the drive shaft chain 10 rotates the gear sprocket 11 of the top drive shaft in concert with the lower key drive shaft. As the key drive shafts rotate 12, the gear drive assembly 3 drives on the gear drive guide track assembly 30 along the gear drive assembly chain 22. As the motor moves the system, the bulkhead 31 moves. The bulkhead 31 can move from the front of the container 40 to the rear of the container 40, and the bulkhead 31 can move from the rear of the container 40 to the front of the container 40.

In the illustrated configuration, the motor assembly comprising a motor 5 and a through shaft speed reducer 4. The motor is coupled to the though shaft speed reducer 4. The motor assembly 5 is coupled to the lower key drive shaft. The motor assembly is coupled to the power collector and receives power from the power collector. The motor assembly is coupled to the beams by a motor mount. An embodiment comprises a motor that is a 3 phase motor. Another embodiment comprises a motor that is capable of creating clockwise and counterclockwise rotation. As the motor rotates the drive shafts 12, the bulkhead 31 moves across the roller assembly 6 unloading the cargo of the container.

In the illustrated example, the bulkhead 31, in addition to the four points of contact with the container, is illustrated with casters 9 coupled to the bottom portion of the frame assembly 2 for discussion sake. However, in certain embodiments casters 9 are not necessary. For instance, the bulkhead may slide smoothly along the roller floor that casters are not needed. For instance, when the bulkhead is used to unload light weight cargo, it may require less force to move the cargo.

In the illustrated example, the bulked has additional support contacts comprising additional support casters 14 coupled to the left and right sides of the bulkhead 31 and to the sidewalls of the container 40. The additional support casters 14 as illustrated are for discussion sake. The addition of support casters 14 are advantageous to prevent damage from traveling over the road. However, in certain embodiments, the support casters 14 are not necessary. Also, in certain embodiments, it is sufficient to have only one additional support caster. For instance, when the bulkhead is used a container that is not transported over the road, or when an instance where the container is traveling smooth roads. An embodiment of the support caster 14 coupled to the bulkhead is where the casters are mounted on a mounting plate and coupled to the frame. Another embodiment, the caster may have a spring mechanism allowing the casters 14 to stay in continuous contact with the container, even in an instant where the container walls are corrugated. Another embodiment may have the support casters mounted to a mounting plate with a spring mechanism.

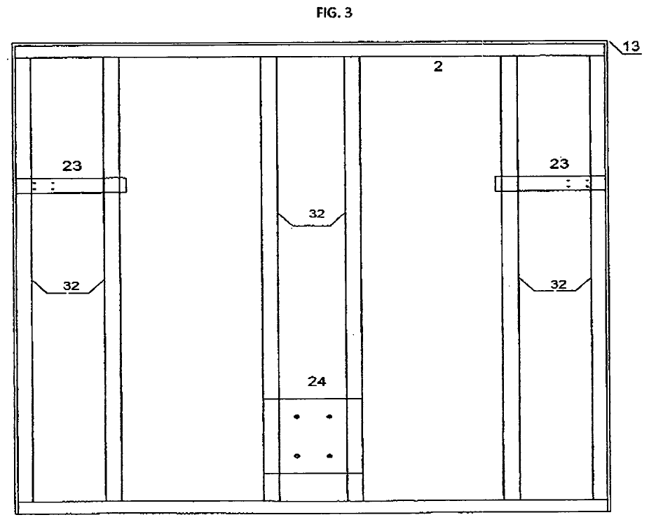

Referring to FIG. 3, a front view of the frame assembly 2 of the bulkhead 31. The frame assembly 2 comprising a rectangular shape; beams 32; friction reduction couplers; and a composite skin. In FIG. 3, the composite skin 13 is transparent in order to see the frame assembly. The illustration of the composite skin is for sake of discussion. However, in certain applications, a composite skin is not necessary. Also, in certain applications, it is sufficient to have a partial composite skin, e.g., the composite skin covering portions of the frame. In yet further configurations, the skin can extend from the width of the frame and extending partially to the midpoint of the height of the frame. In some configurations the skin can be coupled to the frame in panels. In yet further configurations, the skin can be a single covering, spanning the entire front of the frame assembly. The skin provides structure to the bulkhead, and protects the internal components of the bulkhead from debris, dirt and other contaminants. Moreover, the skin protects the cargo within the container from becoming entangled with the bulkhead.

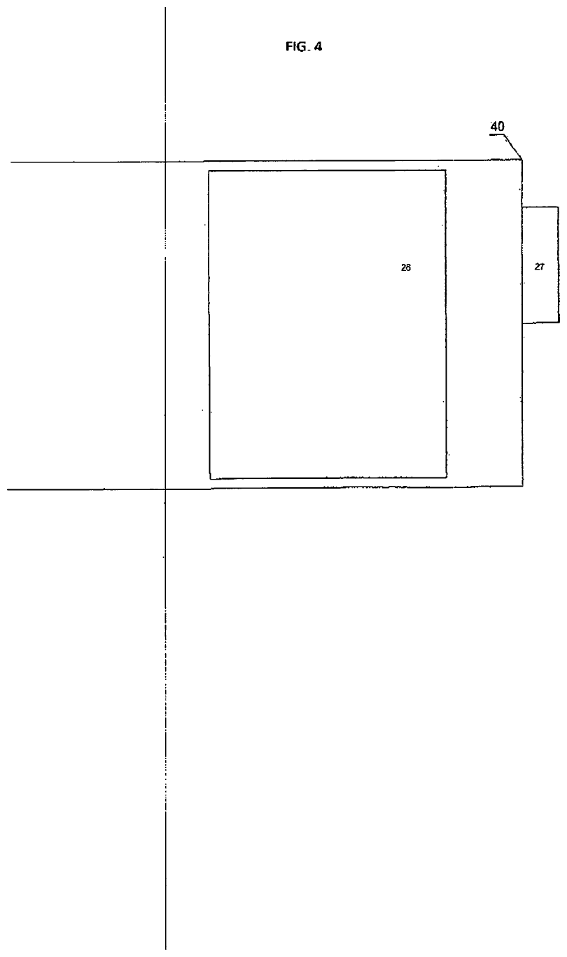

Referring to FIG. 4, a birds eye view from the top of the container 40 illustrating the solar panels 26, coupled to the top of the container 40, and the control enclosure 27 coupled the container. The solar panels 26 are for sake of discussion. However, in certain embodiments, the solar panels 26 are not necessary. Also in certain embodiments, it may be necessary for more solar panels. The addition of the solar panels can be advantageous, such as to allow the batteries to recharge while traveling in transportation. An embodiment of the automatic self-unloading material handling system having solar panels would allow the battery to stay charged longer, and reduce the need for the replacement of batteries. Another embodiment may not need the use of the solar panels due to a shorter route of transportation. Further, the embodiment of the automatic self-unloading material handling system is customizable to the user specific need.

Referring to FIG. 5, an embodiment of the automatic self-unloading material handling system comprising an operator control station. The control stations is located at the rear of the container, and is coupled to a programmable logic center located within the control enclosure. The operator control station allows for an operator to manually control the automatic self-unloading material handling system. The operator control station is included for sake of discussion. However, in certain applications, a control station is not necessary. For instance, an operator could operate the automatic self-unloading material handling system from the control enclosure.

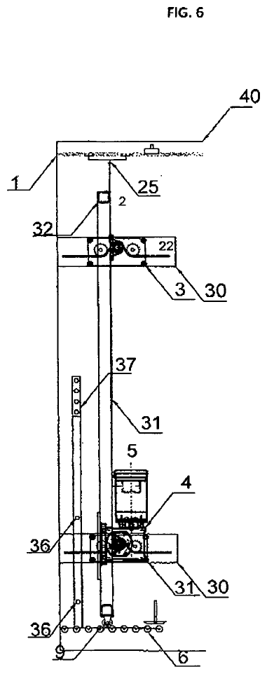

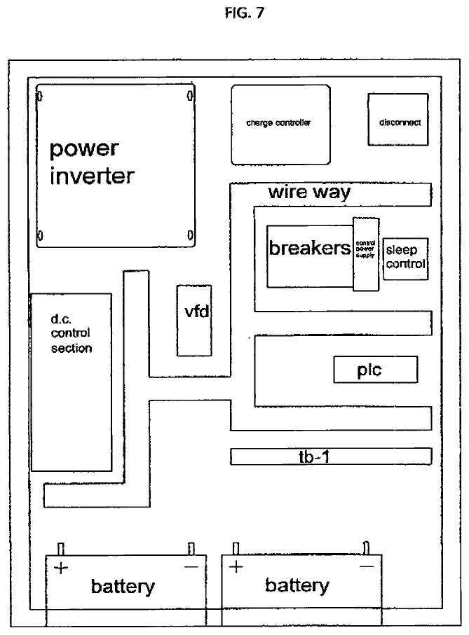

Referring to FIG. 6, a side view of the automatic self-unloading material handling system, with the bulkhead at the rear of the trailer. FIG. 6 includes for discussion a control eye. An embodiment of the control eye is a photoelectric eye. The control eye is included for sake of discussion. However, in certain applications, a control eye is not necessary. Also, in certain applications may require more control eyes. The control eye is coupled to the programmable logic center, and provides information to the variable frequency drive. The control eye allows for the automatic self-unloading material handling system to be programmable. In certain applications, the automatic self-unloading material handling system advances until the control eye is blocked. In yet further applications, the control eye allows the bulkhead to advance until the eye is not blocked completely autonomously unloading the entire cargo load of the container.

Referring to FIG. 7, a view of the control enclosure (also referred to the control panel). The control enclosure comprises a power circuit; a battery; a programmable logic center; a sleep control; and a variable frequency drive. The control enclosure houses the various components utilized to program the automatic self-unloading material handling system and provide power to the automatic self-unloading material handling system.

Conventional control panels continuously supply power to the unit controlled, this method rapidly depletes any electrical charge stored in the batteries. The control panel of the automatic self-unloading material handling system, comprises a sleep control. The sleep control allows the system to conserve power when the system is not in use. Conventional unloading systems did not need to have a sleep control due to the power being supplied externally by a facility, or the tractor, or by other supplied means. However, utilizing the sleep control in the disclosed automatic self-unloading material handling system, allows for the system to operate autonomously

Moreover, the automatic self-unloading material handling system can be programmable with a various functions. The automatic self-unloading material handling system can be programmed to completely unload the container, partially unload the container, and various states of unloading the container programmed to user-specific needs. Another embodiment of the programmable function of the automatic self-unloading material handling system is to be programmed with a return to home function that allows the bulkhead to return to the front of the container after unloading the container. Another embodiment of the programmable feature allows the user-specific needs to program various aspects and locations for the bulkhead to move to.

Further, although the above description describes the automatic self-unloading material handling system for installation in new containers, it is conceivable that existing containers can be retrofitted with the automatic self-unloading material handling system fabricated in accordance with different embodiments.

The terminology used herein is for the purpose of describing particular embodiments only and is not intended to be limiting for the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed:

1. An Automatic self-unloading material handling system comprising:
a container comprising a bottom floor with a roller assembly coupled to the bottom floor; and
a control enclosure coupled to the container comprising:
a power circuit;
a battery, coupled to the power circuit;
a programmable logic center coupled to the power circuit;
a variable frequency drive, coupled to the programmable logic center;
a sleep control coupled to the power circuit; and
a power track comprising an electrical conveyance, having a proximal end and a distal end, the proximal end coupled to the variable frequency drive of the control enclosure, the distal end coupled to a power collector; and
a first gear drive guide track assembly comprising:
a first guide track comprising a composite material, formed as a guide track coupled to an upper portion of a side wall of the container, at a height corresponding proximal to a top of a bulkhead assembly; and
a first gear drive chain, coupled to the guide track; and
a first gear drive assembly, coupled to the gear drive chain; and
a second gear drive guide track assembly comprising:
a second guide track comprising a composite material, formed as a guide track coupled to an upper portion of a second side wall of the container, opposite of the first gear drive track assembly, at a height corresponding proximal to the top of the bulkhead assembly; and
a second gear drive chain, coupled to the second guide track; and
a second gear drive assembly, coupled to the gear drive chain; and
a third gear drive guide track assembly comprising:
a third guide track comprising a composite material, formed as a guide track coupled to a lower portion of the side wall of the container, positioned below the first gear drive track assembly, at a height corresponding proximal to a bottom of the bulkhead assembly; and
a third gear drive chain, coupled to the third guide track; and
a third gear drive assembly, coupled to the third gear drive chain; and
a fourth gear drive guide track assembly comprising:
a fourth guide track comprising a composite material, formed as a guide track coupled to a lower portion of the second side wall of the container, positioned below the second gear drive track assembly, at a height corresponding proximal to the bottom of the bulkhead assembly; and
a fourth gear drive chain, coupled to the fourth guide track; and
a fourth gear drive assembly, coupled to the fourth gear drive chain; and
the bulkhead assembly comprising:
a frame assembly, comprising:
a rectangular frame comprising:
a top portion;
a bottom portion;
a right portion;
a left portion;
a front;
a back;
beams, providing support, comprising:
top distal ends, that are coupled to the top portion of the frame; and
fronts; and
backs; and
bottom distal ends, coupled to the bottom portion of the frame; and
top friction reducing couplings, coupled to the back of the beams equally spaced proximal to the top distal ends of the beams, and consistently aligned with corresponding top friction reducing couplings on corresponding beam, allowing for a top key drive shaft to be coupled to the beam levelly; and
bottom friction reducing couplings coupled to the back of the beams equally spaced proximal to the bottom distal ends of the beams, and consistently aligned with corresponding bottom friction reducing couplings on corresponding beams, allowing for a bottom key drive shaft to be coupled to the beams levelly; and
a composite skin, coupled to the front of the rectangular frame;
the top key drive shaft assembly, coupled to the aligned top friction reducing couplings of the frame assembly comprising:
a left distal end; and
a first spline slip coupling, coupled to the left distal end of the top key drive shaft assembly, and coupled to the first gear drive assembly;
a right distal end; and
a midpoint, between the left distal end and the right distal end; and
a key portion, between the first midpoint of the right distal end of the top key drive shaft assembly; and
a first gear sprocket comprising an internal diameter, defining an orifice with a matching key portion, allowing the top key drive shaft to pass through, with the matching key portion to the key portion coupled to the key portion of the top key drive shaft assembly;
second spline slip coupling, coupled to the right distal end of the top drive shaft, and the second spline slip coupling is coupled to the second gear drive assembly;
the bottom key drive shaft assembly, coupled to the aligned bottom friction reducing couplings of the frame assembly, comprising:
a left distal end; and
a first spline slip coupling, coupled to the left distal end of the bottom key drive shaft assembly, and coupled to the third gear drive assembly;
a right distal end; and
a midpoint, between the left distal end and the right distal end; and
a key portion, between the midpoint of the bottom key drive assembly and the right distal end of the bottom key drive shaft assembly, in a longitudinal position correlating to the key portion of the top drive shaft assembly; and
a second gear sprocket comprising an internal diameter, defining an orifice with a matching key portion, for the bottom key drive shaft to pass through, with the matching key portion to the key portion of the bottom key drive shaft assembly coupled to the key portion of the bottom key drive shaft assembly;
a second spline slip coupling, coupled to the right distal end of the bottom drive shaft, and the second spline slip coupling coupled to the fourth gear drive assembly; and
a motor assembly comprising:
a motor coupled to beams and coupled to the power collector; and
a through shaft speed reducer coupled to the motor, and the through shaft speed reducer coupled to the bottom key drive shaft assembly; and
a endless drive shaft chain coupled to the first gear sprocket and the second gear sprocket.

2. The Automatic material handling unloading system of claim 1, further comprising solar panels, wherein the solar panels are coupled to the exterior of the container, and the solar panels are coupled to a charging controller coupled to the power circuit of the control enclosure.

3. The Automatic material handling unloading system of claim 1, further comprising casters coupled to the bottom of the frame assembly.

4. The Automatic material handling unloading system of claim 1, further comprising an operator control station, wherein the operator control station is coupled to the programmable logic center, and the operator control station is proximal to the rear of the container.

5. The Automatic material handling unloading system of claim 1, further comprising control eyes, the control eyes being proximal to the rear opening of the container and coupled proximal to the bottom floor of the container, wherein the control eyes are coupled to the programmable logic center.

6. The Automatic material handling unloading apparatus of claim 1, where the roller assembly of the bottom floor is coupled to the motor assembly, allowing the roller assembly to roll in relation to the drive shafts.

7. The automatic material handling unloading system of claim 1, further comprising spring loaded casters coupled to the left and the right portion of the frame assembly.
